(19) United States
(12) Patent Application Publication
(10) Pub. No.: US 2012/0330824 A1
(43) Pub. Date: Dec. 27, 2012

(54) CASH RETRIEVAL USING PAYMENT PROVIDER

(75) Inventors: Genfu Ng, Omaha, NE (US); Jennifer Ludgate, LaVista, NE (US); Ronald Snodgrass, Omaha, NE (US); Katherine Pettengill, Omaha, NE (US)

(73) Assignee: EBAY INC., SAN JOSE, CA (US)

(21) Appl. No.: 13/529,972

(22) Filed: Jun. 21, 2012

Related U.S. Application Data
(60) Provisional application No. 61/500,573, filed on Jun. 23, 2011.
(60) Provisional application No. 61/500,860, filed on Jun. 24, 2011.

(51) Int. Cl. G06Q 20/10

(52) U.S. Cl. 705/39

(57) ABSTRACT

A payment provider receives a request from a sender to send cash to a recipient, where the request includes an identifier, such as a phone number, of the recipient and an amount to send. If the request can be approved, the payment provider generates a one-time code associated with the request and transmits the code to the recipient. The recipient is then able to enter, present, or otherwise communicate the code to a cash dispenser (such as an ATM, kiosk, clerk or teller), which then communicates the code and other needed information to the payment provider. If approved, the cash dispenser can give the cash to the recipient. Both sender and recipient are not required to have accounts with the payment provider or a bank.

### CROSS REFERENCE TO RELATED APPLICATION

The present application claims priority to U.S. Provisional Appl. Ser. No. 61/500,573, filed Jun. 23, 2011 and also claims priority to U.S. Provisional Appl. Ser. No. 61/500,860, filed Jun. 24, 2011, which are incorporated by reference in its entirety.

### BACKGROUND

1. Field of the Invention

The present invention generally relates to financial transactions, and in particular, to retrieving cash.

2. Related Art

Typically, when a user needs cash, the user goes to an ATM or other cash dispensing machine, inserts a bank/debit/ATM card, enters the user's login credentials, and receives the cash. The user may also go to a bank or other manned location, present a check or withdrawal slip, and receive the cash. In these situations, the user has to have a bank account associated with the ATM or cash dispensing location. The user may also want to send cash to another. Again, the user will be required to have a bank account from which to withdraw the funds.

However, there may be many situations where the user does not have a bank account, thereby making cash withdrawal or sending cash by the user difficult, if not impossible. Such situations may occur if the user is a child or student.

### SUMMARY

According to one embodiment, a sender has an account with a payment provider, but the recipient does not have an account with the payment provider. The recipient will still be able to receive cash from the sender by the sender logging into the sender's payment provider account and then entering the recipient's phone number and amount. The recipient will then receive a message with a code on the recipient's device (which can be a cell phone, PC, tablet, etc.). The recipient goes to an ATM, which is defined herein as any manned or unmanned cash dispenser, and enters the code. If verified, the recipient receives the designated amount.

According to another embodiment, the recipient has an account with the payment provider, but the sender does not. In this embodiment, the sender goes to an ATM, enters bank account information (such as inserting an ATM/bank card and entering in a PIN), selects a screen associated with the payment provider, and enters the recipient's phone number and amount. The recipient receives a message with the code on the recipient's device, goes to an ATM, enters the code, and receives the amount if the code is verified.

As a result, a user can send or receive cash even when one of the parties has no bank account.

These and other features and advantages of the present invention will be more readily apparent from the detailed description of the embodiments set forth below taken in conjunction with the accompanying drawings.

### BRIEF DESCRIPTION OF THE FIGURES

FIG. 1 is an exemplary flowchart showing a process for a sender, who has an account with a payment provider, to send cash to a recipient who does not have an account with the payment provider or a bank account;

FIG. 2 is an exemplary flowchart showing a process for a recipient, who has an account with the payment provider (but not a bank account), to receive cash from a sender, who does not have an account with the payment provider, but has an account with a banking entity;

FIG. 3 is an exemplary flowchart showing a process for a user to use the services of a payment provider at a point of sale without the user having a wallet or mobile device;

FIG. 4 is a block diagram of a networked system suitable for implementing the processes described according to an embodiment; and

FIG. 5 is a block diagram of a computer system suitable for implementing one or more components in FIG. 4 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

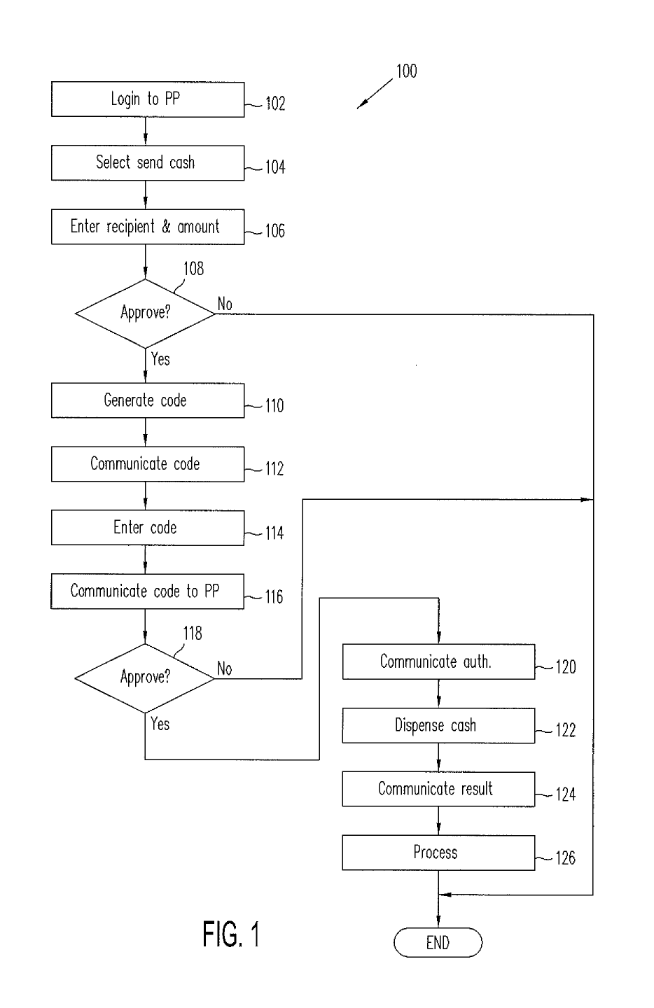

FIG. 1 is a flowchart showing a process 100 in which a sender, who has an account with a payment provider, such as PayPal, Inc. of San Jose, Calif., sends cash to a recipient who does not have an account with the payment provider or a bank account, according to one embodiment. At step 102, the sender first logs into the sender's account with the payment provider. This can be through the sender's PC, mobile device, tablet, or other computing device. The payment provider site may be accessed through an URL or the service accessed through an app on the mobile device. The sender enters the requested log in credentials, such as an identifier (email, user name, phone number, etc.) and/or a password or PIN.

Once the sender has accessed the sender's account on the payment provider site, the sender selects, at step 104, a link, tab, or button indicating a service or option for the sender to send money. This can be through a tap on a touch-screen, clicking with a mouse or pointer, or with a voice command.

The user may then be asked to enter a recipient identifier and the amount to send, at step 106. The identifier, in one embodiment, is the recipient's mobile phone number. Other identifiers may include an email address, physical address, fax number, or another recipient phone number. The identifier may be selected from a contact list of the user/sender, selected from a drop-down menu, or entered via a keypad or microphone on the device. The amount to be sent may be selected from a drop-down menu of previously sent amounts or standard amounts set by the user or payment provider or from the user entering an amount from a keypad or microphone of the user device.

At step 108, the payment provider determines whether such a payment can be sent, such as determining whether the amount is within an acceptable amount for the sender. Other factors may include whether the amount is over a total allowable amount, whether the recipient is authorized to receive the payment, whether the payment request exceeds a transaction total (number of transactions allowed as opposed to amount), whether the sender is at an authorized or prohibited location, whether the sender is at the location of the payment request (such as based on the location of the user's mobile device), etc.

If the requested payment is approved, the payment provider generates, at step 110, a one-time code associated with the request. The one-time code can be a random number (although not required to be) of characters, letters, and/or numbers, in user-readable format or in a barcode/2D code. The code may have an expiration, although no expiration is required. The code may also have other restrictions, such as where the cash can be retrieved by the recipient. For example, the code may not allow the recipient to retrieve cash from an ATM at a casino. Additional restrictions may be time-based, such as not allowing cash to be retrieved from 2 a.m. to 6 a.m.

The payment provider then communicates the code to the recipient at step 112. In one embodiment, the code is sent as a text message to the recipient's mobile device via the identifier entered by the sender. In other embodiments, the code can be sent as a voice message, fax, email, or any other suitable means using the information provided by the sender. Typically, the code is communicated electronically, but in other embodiments, the code can be mailed or otherwise delivered on a physical medium, such as printed on paper.

Once the recipient receives the code, the recipient can go to any cash dispensing machine or facility to retrieve the cash. Examples of cash dispensers include ATMs, kiosks, manned tellers or agents, etc. Once at the cash dispenser, the recipient enters the code, at step 114. Depending on the cash dispenser and format of the code, the recipient may press appropriate buttons on a keypad, say the code to a teller, have the code scanned, present the code to a teller, such as from a mobile device display or on a piece of paper, etc.

The cash dispenser then communicates the code, at step 116, to the payment provider, such as through a computing/communication device of the cash dispenser. This can include an electronic transmission via the device or a phone call from a teller to the payment provider. The payment provider processes the code to determine, at step 118, whether the code can be approved. This determination can include determining whether any limitations or restrictions are present and met, whether the code corresponds to a valid code within the system, whether the code corresponds to the intended recipient (assuming recipient information is conveyed to the payment provider by the cash dispenser), and any other considerations, such as time, location, date, etc. In other embodiments, the cash dispenser processes the code itself, based on information received from the payment provider about the payment request and code. In this situation, the payment provider may communicate the code information to the cash dispenser when or after the payment request is approved and the code is generated by the payment provider.

If the code is approved, the payment provider may communicate, at step 120, an authorization to the cash dispenser (assuming the cash dispenser is unable to approve the code itself). The authorization may include a transaction identifier, an affirmative message, or other indicative information, sent via text or voice. Once authorization is received, the cash dispenser dispenses the cash to the recipient at step 122. For example, an unmanned machine, such as an ATM, may dispense the cash or a teller may give the cash to the recipient.

After the cash is dispensed, the cash dispenser may communicate to the payment provider, at step 124, that the transaction is complete. Communication may be electronic, from cash dispenser device to a payment provider device. At this time, the payment provider further process the payment at step 126, such as debiting an appropriate amount (e.g., the actual cash dispensed plus any service fees) from the sender's account with the payment provider and credit an account associated with the cash dispenser. Note that in other embodiments, the sender's account may be debited at the time the code is generated, sent, or retrieved.

As a result, a sender may have the ability to send cash to a recipient anywhere for the recipient to receive without the recipient having a bank account or an account with the payment provider. This may be especially beneficial for students and children, such that parents or others may be able to send them cash any time, anywhere, with restrictions/limitations as desired.

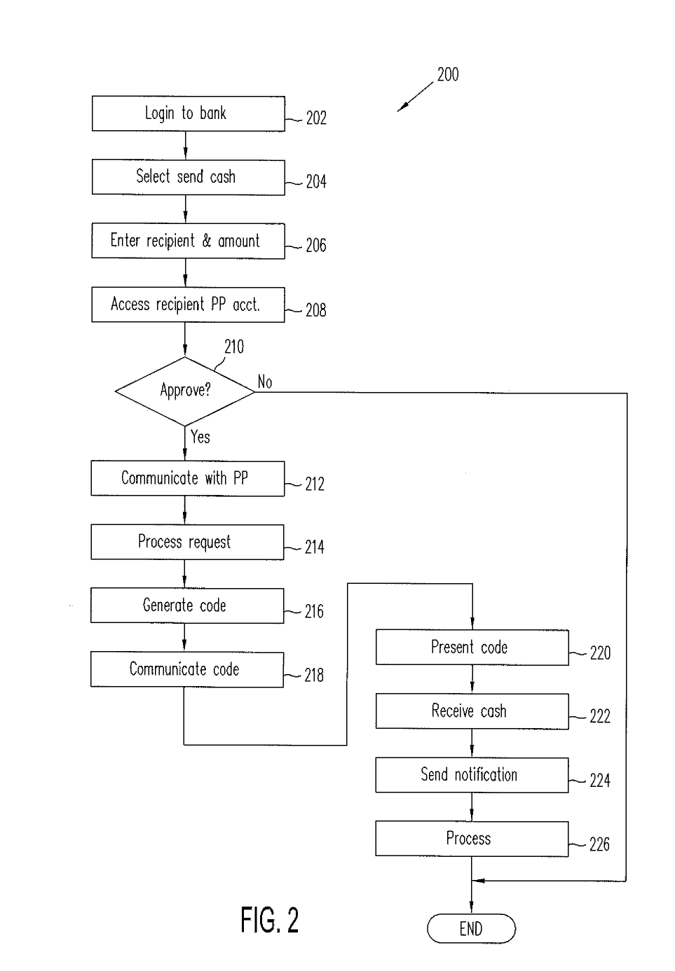

FIG. 2 is a flowchart showing a process 200, according to another embodiment, in which a recipient has an account with the payment provider (but not a bank account) and wants to receive cash from a sender who does not have an account with the payment provider, but does have an account with a banking or financial institution. At step 202, the sender logs into the sender's bank account, such as at a bank ATM, in person at a bank teller, through a bank app from a mobile device, or through a bank's online site from a computing device. The user or sender may be asked to provide a user identifier, such as a user name, account number, email address, phone number, or the like, and a password or PIN.

Once logged in or authorized, the sender, at step 204, selects an option to send cash to a recipient using the payment provider. For example, the user may tell a bank teller, select a button, link, or tab on a display, use a voice command, or other means.

Next, at step 206, the sender may be requested to enter a recipient identifier, such as a phone number, email, physical address, fax number, name, user name, etc., along with an amount to send, such as described above. The recipient identifier allows the payment provider to locate and access, at step 208, the recipient's account with the payment provider, while the amount enables the sender's bank to determine, at step 210, whether the sender is authorized send the requested amount, such as whether there is sufficient funds available in the sender's bank account. Similar to the earlier embodiment, the bank may perform other analysis to determine whether the request can be approved.

If approved, the bank (or associated bank device/server) communicates, at step 212, with the payment provider, which may include sending an indication that bank has approved the sender to send the requested funds, the amount to be sent, bank information, location information of the bank and/or bank device. The payment provider receives information about the payment request and processes the request at step 214. Processing may include determining whether an account of the recipient can be located based on the received information.

If an account is located, the payment provider may generate a code, at step 216, as before, and send it to the recipient, at step 218, such as through information associated with the recipient account or received from the sender's bank. The code may be sent electronically to a recipient device, such as a smart phone or computing tablet, as discussed herein.

The recipient can then go to a cash dispenser (manned or unmanned) and retrieve the cash by entering or presenting the code, at step 220, again as discussed in more detail herein. After the cash is given to the recipient, at step 222, a notification may be sent, at step 224, from the cash dispenser to the sender's bank and/or the payment provider.

The transaction may then be further processed, at step 226, such as the sender's bank debiting the sender's account with the bank with an appropriate amount (e.g., the actual payment amount plus any service fees), the payment provider debiting a bank's account with the payment provider, and the bank debiting the sender's bank account. Note that this last step may be skipped if the sender's bank account was previously debited, such as when/after the bank approved the request, generated the code, or sent the code. The payment provider may credit an account associated with the cash dispenser.

As a result, a recipient without a bank account may receive cash any time, anywhere. Note that in some embodiments, the bank or financial institution may not require a payment provider to be part of the transaction. In this case, the bank may perform one or more of the steps of the payment provider described above and/or eliminate one or more steps performed by the payment provider.

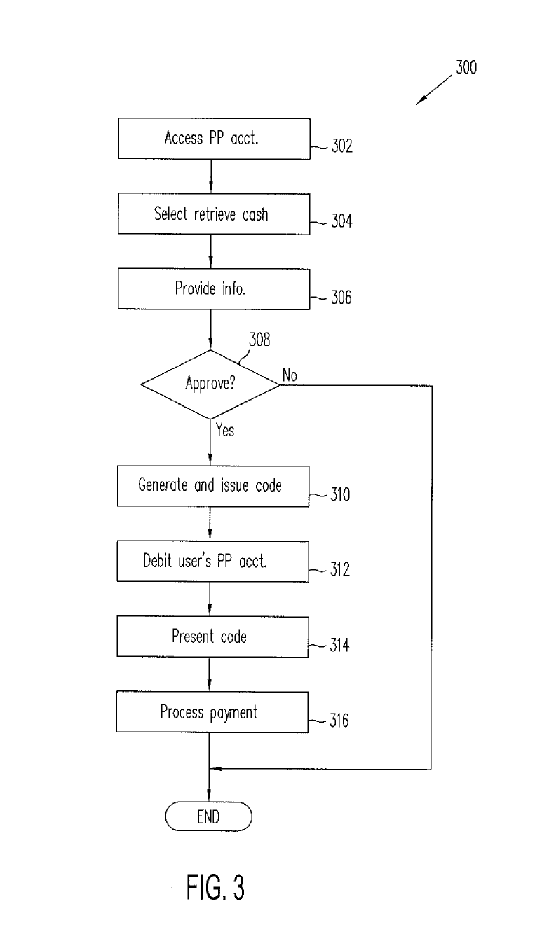

FIG. 3 is an exemplary flowchart showing a process 300 for a user to use the services of a payment provider at a point of sale (POS) without the user having a wallet or mobile device. At step 302, a user accesses the user's account with the payment provider, such as through a machine, such as an ATM or payment terminal managed, run, or associated with the payment provider that allows the user to access the user's account with the payment provider. Access can also be through a teller or person other than the user entering information through a device for the user to access his/her account. Access may be through user credentials, biometrics, and/or other means that are acceptable to the payment provider.

After successful login, the user may select or otherwise convey a desire to retrieve money, at step 304, from the user's payment provider account. This can be through a selection of a button, link, or other visual indicator from the user, merchant, or payment provider device, or using voice to tell a teller or speak into a device. The user may then be requested to provide specific information, which the user does at step 306. This may include specifying an amount to retrieve from the account, such as through a drop-down menu, entering an amount, by a keypad or voice, or verbalizing the amount to a teller.

The request is then processed and a determination made, at step 308, whether the request can be approved. Assuming the request is approved, which may include the payment provider determining whether any and all conditions are met, such as discussed herein, the payment provider may generate and issue the user, at step 310, a code/number, such as the one-time code discussed above. The code can be printed on a receipt, in the form of a barcode/2D code, presented electronically on a user device, such as sent via email or text.

The user's account with the payment provider is debited the corresponding amount at step 312. The user is then able to use the receipt, similar to a gift card or gift receipt, at the POS or other location/site for purchases and/or redemption for cash. In other embodiments, the user account is not debited until the code is actually used, as opposed to simply being generated and issued.

At step 314, the user presents the code or receipt for a purchase, such as the POS. The code is captured by the merchant, such as through a scan of the code, entering the code manually by keypad or voice, sending the code to the merchant, or other suitable means. The POS or merchant then processes the code, at step 316, which can be similar to gift receipt processing. For example, the merchant may match the code with unused or valid credit associated with the code, confirm the code/receipt is authentic, and/or other processing means. This may include communication with the payment provider, thereby enabling the user to make a purchase or cash withdrawal through the user's payment provider account even when the user does not have his wallet or phone. Any unused funds of the gift receipt may be returned back to the user's account or returned as cash at the POS.

Note that one or more steps described herein may be omitted, combined, or performed in a different sequence as desired and appropriate.

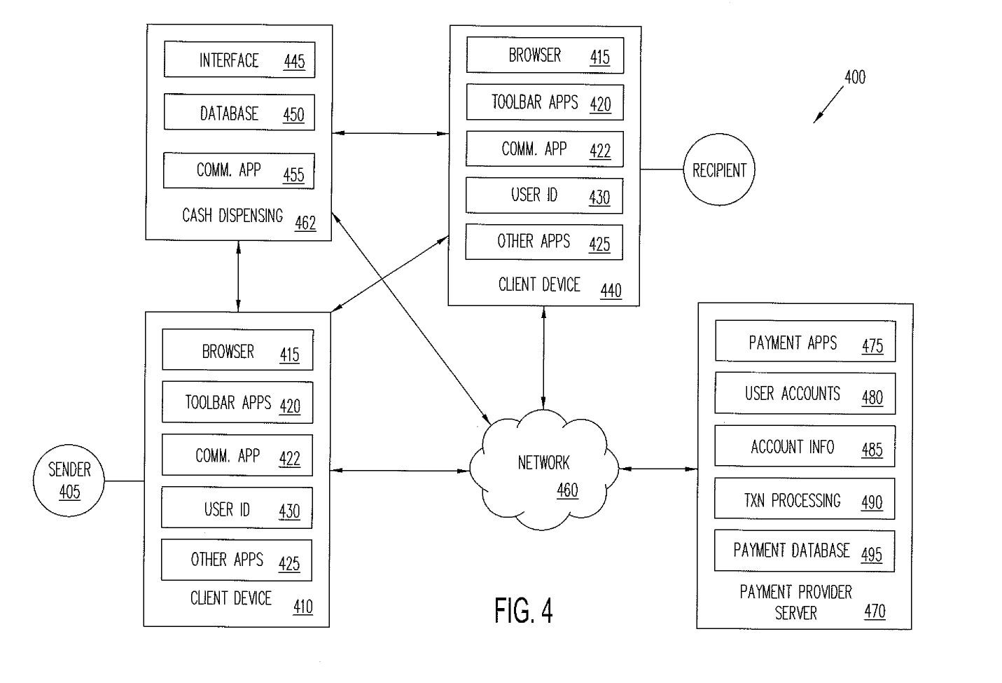

FIG. 4 is a block diagram of a networked system 400 configured to handle a financial transaction between a sender, a recipient, and a payment provider, such as described above, in accordance with an embodiment of the invention. System 400 includes a sender or client device 410, a receiver or client device 440, a cash dispenser 462, and a payment provider server 470 in communication over a network 460. Payment provider server 470 may be maintained by a payment provider, such as PayPal, Inc. of San Jose, Calif. A sender 405 utilizes client device 410 to perform transactions for sending cash to a recipient. Client device 440 and cash dispenser 462 may communicate with payment provider servicer 470 over network 460 to effect the transactions as described above. Note that user 405 may interact with client device 440 and cash dispenser 462 directly without client device 410.

Client device 410, client device 440, cash dispenser 462, and payment provider server 470 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

Network 460 may be implemented as a single network or a combination of multiple networks. For example, in various embodiments, network 460 may include the Internet or one or more intranets, landline networks, wireless networks, and/or other appropriate types of networks.

Client device 410 may be implemented using any appropriate hardware and software configured for wired and/or wireless communication over network 460. For example, in one embodiment, the two user devices may be implemented as a personal computer (PC), a smart phone, personal digital assistant (PDA), laptop computer, and/or other types of computing devices capable of transmitting and/or receiving data, such as an iPad™ from Apple™.

Client device 410 may include one or more browser applications 415 which may be used, for example, to provide a convenient interface to permit sender 405 to browse information available over network 460. For example, in one embodiment, browser application 415 may be implemented as a web browser configured to view information available over the Internet. Client device 410 may also include one or more toolbar applications 420 which may be used, for example, to provide client-side processing for performing desired tasks in response to operations selected by sender 405. In one embodiment, toolbar application 420 may display a user interface in connection with browser application 415 as further described herein.

Client device 410 may further include other applications 425 as may be desired in particular embodiments to provide desired features to client device 410. For example, other applications 425 may include security applications for implementing client-side security features, programmatic client applications for interfacing with appropriate application programming interfaces (APIs) over network 460, or other types of applications. Applications 425 may also include email, texting, voice and IM applications that allow sender 405 to send and receive emails, calls, and texts through network 460, as well as applications that enable the user to make perform transactions through the payment provider as discussed above. Client device 410 may include one or more user identifiers 430 which may be implemented, for example, as operating system registry entries, cookies associated with browser application 415, identifiers associated with hardware of client device 410, or other appropriate identifiers, such as used for payment/user/device authentication. In one embodiment, user identifier 430 may be used by a payment service provider to associate sender 405 with a particular account maintained by the payment provider as further described herein. A communications application 422, with associated interfaces, enables client device 410 to communicate within system 400. Client device 410 may further be used to generate and/or display codes as described above.

Client device 440, in this embodiment, is similar to client device 410, in that client device 440 can be used by the recipient to communicate with a financial institution or payment provider to receive a code to retrieve cash at cash dispenser 462.

Cash dispenser 462, in this embodiment, is a separate unmanned device, such as an ATM or kiosk. In other embodiments, cash dispenser 462 is operated by or associated with a person. Cash dispenser 462 is used to dispense cash to the recipient.

Cash dispenser 462 has an interface 445, which may be configured to dispense cash or other value items to the recipient. For example, the interface may be a slot or opening that dispenses cash or a voucher to the recipient. Furthermore, interface 445 may include an input that enables the recipient or sender to enter information, such as an amount, code, and/or identifiers.

A database 450, such as memory, can store information related to the value item, voucher, and/or the user. A communication application 455 enables cash dispenser 462 to communicate with payment provider server 470 to process the transaction if needed. For example, communication application 455 may transmit value item information and/or user information to payment provider server 470.

Payment provider server 470 may be maintained, for example, by an online payment service provider which may provide financial services. In this regard, payment provider server 470 includes one or more payment applications 475 which may be configured to interact with client device 410, client device 440, and/or cash dispenser 462 over network 460 to facilitate obtaining or dispensing cash.

Payment provider server 470 also maintains a plurality of user accounts 480, each of which may include account information 485 associated with individual users. For example, account information 485 may include private financial information of users of devices such as account numbers, passwords, device identifiers, user names, phone numbers, credit card information, bank information, account restrictions, and/or other financial information which may be used to facilitate transactions.

A transaction processing application 490, which may be part of payment application 475 or separate, may be configured to receive information from the client devices and/or cash dispenser 462 for processing and storage of data, such as codes, in a payment database 495. Transaction processing application 490 may include one or more applications to process information for processing a payment request or cash dispensing as described herein. Payment application 475 may be further configured to determine the existence of and to manage accounts, as well as create new accounts if necessary, such as the set up, management, and use of cash dispensing codes.

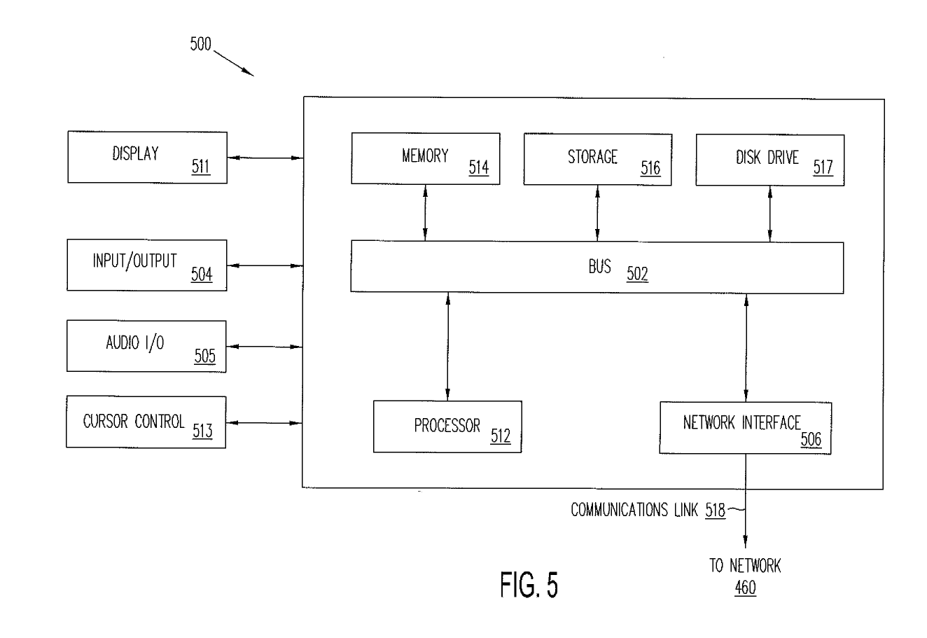

FIG. 5 is a block diagram of a computer system 500 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons or links, scanning a code, etc., and sends a corresponding signal to bus 502. I/O component 504 may also include an output component, such as a display 511 or printer and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a cash dispenser, a financial institution, or a payment provider server via network 460. In one embodiment, the transmission is wireless, although other transmission mediums and methods may also be suitable. A processor 512, which can be a micro-controller, digital signal processor (DSP), or other processing component, processes these various signals, such as for display on computer system 500 or transmission to other devices via a communication link 518. Processor 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information, wherein the information comprises codes associated with requests to transfer money from a user account; and
one or more processors in communication with the memory and adapted for
receiving, by a payment provider, a request from a sender to send cash to a recipient;
processing the request, wherein the processing includes processing a recipient identifier and an amount;
generating a one-time code associated with the request;
transmitting the code to the recipient;
receiving the code from a cash dispenser, wherein the recipient enters, communicates, or presents the code to the cash dispenser; and
authorizing, to the cash dispenser, dispensing of cash to the recipient.

2. The system of claim 1, wherein the sender has an account with the payment provider and the recipient does not have an account with the payment provider.

3. The system of claim 1, wherein the recipient identifier comprises a recipient phone number.

4. The system of claim 1, wherein the one or more processors further credits an account of the cash dispenser after the cash is dispensed.

5. The system of claim 1, wherein the request is received through an account of the sender's with a financial institution different from the payment provider and wherein the sender does not have an account with the payment provider.

6. The system of claim 5, wherein the cash is debited from the account of the sender's with the financial institution.

7. The system of claim 1, wherein the one-time code includes restrictions of use.

8. A method, comprising:
receiving a request from a sender to send cash to a recipient;
processing the request, wherein the processing includes processing a recipient identifier and an amount;
generating, electronically by a processor of a payment provider, a one-time code associated with the request;
transmitting the code to the recipient;
receiving the code from a cash dispenser, wherein the recipient enters, communicates, or presents the code to the cash dispenser; and
authorizing, to the cash dispenser, dispensing of cash to the recipient.

9. The method of claim 8, wherein the sender has an account with the payment provider and the recipient does not have an account with the payment provider.

10. The method of claim 8, further comprising crediting an account of the cash dispenser after the cash is dispensed.

11. The method of claim 8, wherein the request is received through the sender's account with the payment provider.

12. The method of claim 8, wherein the request is received through an account of the sender's with a financial institution different from the payment provider and wherein the sender does not have an account with the payment provider.

13. The method of claim 12, wherein the cash is debited from the account of the sender's with the financial institution.

14. The method of claim 8, wherein the one-time code includes restrictions of use.

15. A non-transitory machine-readable medium comprising a plurality of machine-readable instructions which when executed by one or more processors of a server are adapted to cause the server to perform a method comprising:
receiving, by a payment provider, a request from a sender to send cash to a recipient;
processing the request, wherein the processing includes processing a recipient identifier and an amount;
generating a one-time code associated with the request;
transmitting the code to the recipient;
receiving the code from a cash dispenser, wherein the recipient enters or presents the code to the cash dispenser; and
authorizing, to the cash dispenser, dispensing of cash to the recipient.

16. The non-transitory machine-readable medium of claim 15, wherein the sender has an account with the payment provider and the recipient does not have an account with the payment provider.

17. The non-transitory machine-readable medium of claim 15, wherein the method further comprises crediting an account of the cash dispenser after the cash is dispensed.

18. The non-transitory machine-readable medium of claim 15, wherein the request is received through the sender's account with the payment provider.

19. The non-transitory machine-readable medium of claim 15, wherein the request is received through an account of the sender's with a financial institution different from the payment provider and wherein the sender does not have an account with the payment provider.

20. The non-transitory machine-readable medium of claim 18, wherein the cash is debited from the account of the sender's with the financial institution.

21. The non-transitory machine-readable medium of claim 15, wherein the one-time code includes restrictions of use.
